(19) United States
(12) Patent Application Publication
(10) Pub. No.: US 2026/0163012 A1
(43) Pub. Date: Jun. 11, 2026

(54) CURRENT COLLECTOR FOR ZINC-ION BATTERY, MANUFACTURING METHOD THEREFOR, AND ZINC-ION BATTERY

(71) Applicant: INDUSTRY-ACADEMIC COOPERATION FOUNDATION GYEONGSANG NATIONAL UNIVERSITY, Gyeongsangnam-do (KR)

(72) Inventors: Geon Hyoung AN, Gyeongsangnam-do (KR); Seo Yeong KIM, Gyeongsangnam-do (KR)

(73) Assignee: INDUSTRY-ACADEMIC COOPERATION FOUNDATION GYEONGSANG NATIONAL UNIVERSITY, Gyeongsangnam-do (KR)

(21) Appl. No.: 18/859,159

(22) PCT Filed: Apr. 14, 2023
(86) PCT No.: PCT/KR2023/005093

§ 371 Date: Oct. 22, 2024

(30) Foreign Application Priority Data
Apr. 26, 2022 (KR) 10-2022-0051574

(51) Int. Cl. H01M 4/66; H01M 4/82; H01M 10/38

(52) U.S. Cl. CPC H01M 4/663; H01M 4/82; H01M 10/38

(57) ABSTRACT

The present invention relates to a current collector for a zinc-ion battery, a manufacturing method therefor, and a zinc-ion battery. A current collector for a zinc-ion battery according to an embodiment of the present invention comprises: a graphene film; and heteroatoms doped in the graphene film.

### TECHNICAL FIELD

The present disclosure relates to a current collector for a zinc-ion battery, a manufacturing method therefor, and a zinc-ion battery.

### BACKGROUND ART

Large-scale energy storage systems (ESS) have emerged as promising devices for managing the energy output of sporadic renewable energy sources, such as wind and solar power. However, since ESSs include battery modules, fire outbreaks may cause financial loss and have a fatal influence on human lives. Therefore, batteries for ESSs need to have high energy density and safety.

Due to the high safety, low cost, and high ionic conductivity of aqueous electrolytes, aqueous secondary batteries have emerged as promising candidates for large-scale EES. Among many candidates for aqueous batteries, aqueous zinc (Zn)-ion batteries (ZIBs) have recently attracted attention as promising EES due to the high safety, low redox potential, high theoretical capacity, and non-toxicity thereof. In general, a ZIB includes Zn metal as both an anode and a current collector, an aqueous electrolyte, a separator, an inorganic cathode material, and a current collector for a cathode. A cathode of the ZIB is fabricated by casting an electrode material (typically, MnO₂ and V₂O₅) on the current collector.

The current collector not only supports an active material of the cathode but also collects electrons produced by an electrochemical reaction of Zn ions to an external circuit, to convert chemical energy into electrical energy. In addition, the current collector needs to exhibit a high electrical conductivity and wettability to reduce cell resistance and enhance the mechanical stability of the current collector in contact with the aqueous electrolyte over a potential window of electrode materials during cycling to achieve a ZIB with excellent electrochemical performance. However, weakly acidic aqueous electrolytes used in ZIBs prevent the use of conventional metal foils (which are mainly used in lithium-ion batteries (LIBs)) due to easy corrosion of the metal foils. In particular, a corrosion of a foil during cycling results in an electrical exfoliation of the electrode material from the current collector, which results in a high internal resistance of a battery system. Thus, carbon-based current collectors are mainly used as current collectors of ZIBs. However, ZIBs have not yet attracted extensive research attention compared to LIBs.

### DISCLOSURE OF THE INVENTION

### Technical Goals

To solve the above-described problems, the present disclosure provides a current collector for a zinc-ion battery having excellent energy storage performance due to excellent electrical conductivity, charge transfer, ion diffusion ability, wettability, and specific capacity, provides a method of manufacturing the same, and provides a zinc-ion battery.

However, goals to be achieved by the present disclosure are not limited to those described above, and other goals not mentioned above can be clearly understood by one of ordinary skill in the art from the following description.

### Technical Solutions

According to an embodiment of the present disclosure, a current collector for a zinc-ion battery includes a graphene film; and a heteroatom doped in the graphene film.

In an embodiment, the heteroatom may include at least one selected from a group consisting of fluorine (F), nitrogen (N), sulfur (S), boron (B), and phosphorus (P).

In an embodiment, the graphene film may be obtained by stacking 2 to 10 multilayer graphene layers.

In an embodiment, the graphene film may be obtained by removing oxygen-containing groups.

In an embodiment, the current collector for the zinc-ion battery may be co-doped with fluorine (F) and nitrogen (N).

According to another embodiment of the present disclosure, a method of manufacturing a current collector for a zin-ion battery includes preparing a graphene film; coating the graphene film with a compound including a heteroatom; and heat-treating the graphene film coated with the heteroatom.

In an embodiment, the preparing of the graphene film may include preparing a mixed solution by mixing multilayer graphene and a polymer in a solvent; casting the mixed solution on a mesh and drying the graphene film; and separating the dried graphene film from the mesh.

In an embodiment, the multilayer graphene may be obtained by stacking 2 to 10 graphene layers.

In an embodiment, the polymer may include at least one selected from a group consisting of polyvinylidene fluoride (PVDF), polyvinylpyrrolidone (PVP), polyvinyl alcohol (PVA), polyvinyl acetate (PVAc), polystyrene (PS), polymethyl methacrylate (PMMA), poly(n-butyl acrylate) (PBA), polyacrylonitrile (PAN), polyaniline (PANi), polyacrylic acid (PAA), polyester-amides (PEA), polyethylene (PE), polyvinyl chloride (PVC), polyvinylidene chloride (PVDC), polyurethane (PU), polychloroprene, polyisoprene, and polybutadiene.

In an embodiment, the solvent may include water, an organic solvent, or both.

In an embodiment, the organic solvent may include at least one selected from a group consisting of N-methyl-2-pyrrolidone (NMP), N,N-dimethylacetamide (DMAc), dimethylformamide (DMF), dimethyl sulfoxide (DMSO), tetrahydrofuran (THF), pyridine, propanol, acetone, methanol, and ethanol.

In an embodiment, the casting of the mixed solution on the mesh and drying of the graphene film may include casting the mixed solution on a metal mesh, and drying the graphene film at a temperature of 30° C. to 80° C. and in a vacuum or an atmosphere including at least one of air, oxygen, and an inert gas.

In an embodiment, the compound including the heteroatom may include at least one selected from a group consisting of ammonium fluoride (NH₄F), ammonium bifluoride (NH₄HF₂), sodium borohydride (NaBH₄), lithium borohydride (LiBH₄), potassium borohydride (KBH₄), magnesium borohydride (Mg(BH₄)₂), calcium borohydride (Ca(BH₄)₂), strontium borohydride (Sr(BH₄)₂), tris(trimethylsilyl)phosphine, tris(dimethylamino)phosphine, trioctylphosphine (TOP), tri-butylphosphine, tri-phenylphosphine, tri(o-toyl) phosphine, trioctylphosphine oxide (TOPO), triphenyl phosphine oxide, tributyl phosphine oxide, sodium sulfide nonahydrate, thiourea, and ammonium persulfate.

In an embodiment, the heat-treating of the graphene film coated with the heteroatom may include performing a thermal reduction process at a temperature of 300° C. to 600° C. and in a vacuum or an atmosphere including at least one of air, oxygen, and an inert gas.

In an embodiment, an oxygen-containing group of the graphene film may be removed by the heat-treating.

According to still another embodiment of the present disclosure, a zinc-ion battery includes the current collector for the zinc-ion battery described above, or a current collector for a zinc-ion battery manufactured by the method described above; a cathode; a zinc anode; and a gel electrolyte.

In an embodiment, the gel electrolyte may include at least one selected from a group consisting of polyvinyl alcohol (PVA), zinc sulfate (ZnSO₄), manganese sulfate (MnSO₄), vanadium sulfate (VOSO₄), phosphoric acid (H₃PO₄), sulfuric acid (H₂SO₄), sodium hydroxide (NaOH), potassium hydroxide (KOH), calcium hydroxide (Ca(OH)₂), and magnesium hydroxide (Mg(OH)₂).

In an embodiment, the zin-ion battery may have a maximum energy density of 200 W h kg⁻¹ to 400 W h kg⁻¹ at a power density of 270 W kg⁻¹, and have a maximum energy density of 100 W h kg⁻¹ to 200 W h kg⁻¹ at a power density of 1,800 W kg⁻¹.

In an embodiment, the zin-ion battery may have specific capacities of 150 mAh g⁻¹ to 400 mA hg⁻¹ at a current density of 0.3 A g⁻¹ to 2.0 A g⁻¹, and have a capacitance retention rate of 80% or greater after “120” cycles at a current density of 0.5 A g⁻¹.

### Effects of the Invention

In a current collector for a zinc-ion battery according to an embodiment of the present disclosure, heteroatoms may be doped in a graphene film, to increase an electrical conductivity due to a reduction of oxygen-containing groups and a nitrogen-doping effect, and improve a charge transfer process, which may lead to an increase in an overall specific capacity and rate performance. In addition, due to a fluorine-doping effect, a wettability may be enhanced.

A zinc-ion battery according to an embodiment of the present disclosure is excellent in energy storage performance due to excellent electrical conductivity, charge transfer, ion diffusion ability, and specific capacity. The energy storage performance is enhanced due to the following significant factors. First, an oxygen functional group included in the graphene film may be removed by a thermal reduction process, to enhance the electrical conductivity. In addition, due to the nitrogen-doping effect, the electrical conductivity may be enhanced. Lastly, due to the fluorine-doping effect, the wettability may be enhanced. Due to the above effects, a capacity and cycling performance of a battery may be enhanced.

### BRIEF DESCRIPTION OF THE DRAWINGS

FIG. 1A is a diagram schematically illustrating a process of fabricating a fluorine and nitrogen co-doped improved-quality graphene film (FN-IQGF) using surface functionalization according to an embodiment of the present disclosure, and FIG. 1B is a diagram schematically illustrating a zinc-ion battery (ZIB) including an FN-IQGF as a multifunctional current collector.

FIGS. 2A and 2B illustrate a scanning electron microscopy (SEM) image and an enlarged SEM image of a graphene film (GF), FIGS. 2B and 2E illustrate an SEM image and an enlarged SEM image of an IQGF, FIGS. 2C and 2F illustrate an SEM image and an enlarged SEM image of an FN-IQGF, and FIG. 2G illustrates a photograph of the FN-IQGF in a rolled state.

FIGS. 3A and 3B illustrate low-and high-magnification transmission electron microscopy (TEM) images of an FN-IQGF film according to an embodiment of the present disclosure, and FIG. 3C illustrates energy-dispersive spectrometry (EDS) images with elemental distribution.

FIGS. 4A to 4C illustrate C 1s X-ray photoelectron spectroscopy (XPS) spectra of a GF, an IQGF, and an FN-IQGF according to an embodiment of the present disclosure.

FIG. 4D illustrates percentages of oxygen-containing groups of the GF, the IQGF, and the FN-IQGF according to an embodiment of the present disclosure.

FIG. 4E illustrates F 1s XPS spectra of the GF, the IQGF, and the FN-IQGF according to an embodiment of the present disclosure.

FIGS. 4H to 4J illustrate N 1s XPS spectra of the GF, the IQGF, and the FN-IQGF according to an embodiment of the present disclosure.

FIG. 5A illustrates X-ray diffraction (XRD) patterns of a GF, an IQGF, and an FN-IQGF according to an embodiment of the present disclosure.

FIG. 5B illustrates thermogravimetric analysis (TGA) curves of the GF, the IQGF, and the FN-IQGF according to an embodiment of the present disclosure.

FIG. 5C illustrates a differential scanning calorimetry (DSC) curve of the GF, the IQGF, and the FN-IQGF according to an embodiment of the present disclosure.

FIG. 5D illustrates Raman spectra of the GF, the IQGF, and the FN-IQGF according to an embodiment of the present disclosure.

FIG. 5E illustrates electrical conductivities of the GF, the IQGF, and the FN-IQGF according to an embodiment of the present disclosure.

FIGS. 5F to 5H illustrate results obtained by measuring contact angles of the GF, the IQGF, and the FN-IQGF according to an embodiment of the present disclosure.

FIG. 6A illustrates Nyquist plots of a GF, an IQGF, and an FN-IQGF according to an embodiment of the present disclosure.

FIG. 6A illustrates rate performance of the GF, the IQGF, and the FN-IQGF according to an embodiment of the present disclosure.

FIG. 6C illustrates a result of a comparison between rate performance of the FN-IQGF according to an embodiment of the present disclosure and those of previously reported ZIBs.

FIG. 6D illustrates cyclic stabilities of the GF, the IQGF, and the FN-IQGF according to an embodiment of the present disclosure.

FIG. 6E illustrates a Ragone plot for comparing power densities and energy densities of the GF, the IQGF, and the FN-IQGF according to an embodiment of the present disclosure to power densities and energy densities of previously reported energy storage devices.

FIGS. 7A and 7B illustrate a three-dimensional (3D) surface image and a resultant height plot of a GF electrode according to an embodiment of the present disclosure.

FIGS. 7C and 7D illustrate a 3D surface image and a resultant height plot of an IQGF electrode according to an embodiment of the present disclosure.

FIGS. 7E and 7F illustrate a 3D surface image and a resultant height plot of an FN-IQGF electrode according to an embodiment of the present disclosure.

FIGS. 8A to 8C illustrate cross-sectional SEM images and EDS mappings of a GF electrode, an IQGF electrode, and an FN-IQGF electrode after a cycling test according to embodiments of the present disclosure; and FIG. 8D illustrates a ratio of Mn to Zn obtained from the EDS mappings.

FIG. 9A is a diagram schematically illustrating a structure of an all-solid-state ZIB including an FN-IQGF electrode and a gel electrolyte according to an embodiment of the present disclosure.

FIG. 9B illustrates rate performance of the all-solid-state ZIB according to an embodiment of the present disclosure.

FIG. 9C illustrates Ragone plots for comparing a power density and an energy density of the all-solid-state ZIB according to an embodiment of the present disclosure to those of previously reported all-solid-state energy storage devices.

FIG. 9D illustrates photographs showing voltage conditions of a smartphone, a microcontroller, and a Bluetooth device connected to the all-solid-state ZIB according to an embodiment of the present disclosure in a straight state, a folded state, a cut state, and even under water.

FIG. 10 is a diagram schematically illustrating advantages of an FN-IQGF as a multifunctional current collector according to an embodiment of the present disclosure.

### BEST MODE FOR CARRYING OUT THE INVENTION

Hereinafter, embodiments will be described in detail with reference to the accompanying drawings. However, various alterations and modifications may be made to the embodiments, and the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, components, and/or groups thereof but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In addition, when describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Furthermore, the terms first, second, A, B, and the like, may be used to describe components of the embodiments. These terms are used only for the purpose of discriminating one component from another component, and the nature, the sequences, or the orders of the components are not limited by the terms.

A component, which has the same common function as a component included in any one embodiment, will be described by using the same name in other embodiments. Unless disclosed to the contrary, the description of any one embodiment may be applied to other embodiments, and duplicated descriptions will be omitted.

Hereinafter, a current collector for a zinc-ion battery of the present disclosure, a method of manufacturing the same, and a zinc-ion battery will be described in detail with reference to embodiments and drawings. However, the present disclosure is not limited to the embodiments and drawings.

A current collector for a zinc-ion battery according to an embodiment of the present disclosure includes a graphene film; and a heteroatom doped in the graphene film.

In an embodiment, the heteroatom may include at least one selected from a group consisting of fluorine (F), nitrogen (N), sulfur (S), boron (B), and phosphorus (P).

Desirably, the heteroatom may include fluorine (F) and nitrogen (N).

In an embodiment, the current collector for the zinc-ion battery may be co-doped with fluorine (F) and nitrogen (N).

The current collector for the zinc-ion battery according to an embodiment of the present disclosure may be a fluorine and nitrogen co-doped improved-quality graphene film (FN-IQGF) using surface functionalization.

In an embodiment, the graphene film may be obtained by stacking 2 to 10 multilayer graphene layers; 2 to 8 multilayer graphene layers; 2 to 6 multilayer graphene layers; 2 to 4 multilayer graphene layers; 4 to 10 multilayer graphene layers; 4 to 8 multilayer graphene layers; 4 to 6 multilayer graphene layers; 6 to 10 multilayer graphene layers; 6 to 8 multilayer graphene layers; or 8 to 10 multilayer graphene layers.

Desirably, the graphene film may be obtained by stacking 10 multilayer graphene layers.

In an embodiment, the graphene film may be obtained by removing oxygen-containing groups.

For example, the oxygen-containing groups included in the graphene film may be removed by a thermal reduction process, to enhance the electrical conductivity

In the current collector for a zinc-ion battery according to an embodiment of the present disclosure, heteroatoms may be doped in the graphene film, to increase the electrical conductivity due to a reduction of oxygen-containing groups and a nitrogen-doping effect, and improve a charge transfer process, which may lead to an increase in an overall specific capacity and rate performance. In addition, due to a fluorine-doping effect, a wettability may be enhanced.

A method of manufacturing a current collector for a zinc-ion battery according to an embodiment of the present disclosure includes preparing a graphene film; coating the graphene film with a compound including a heteroatom; and heat-treating the graphene film coated with the heteroatom.

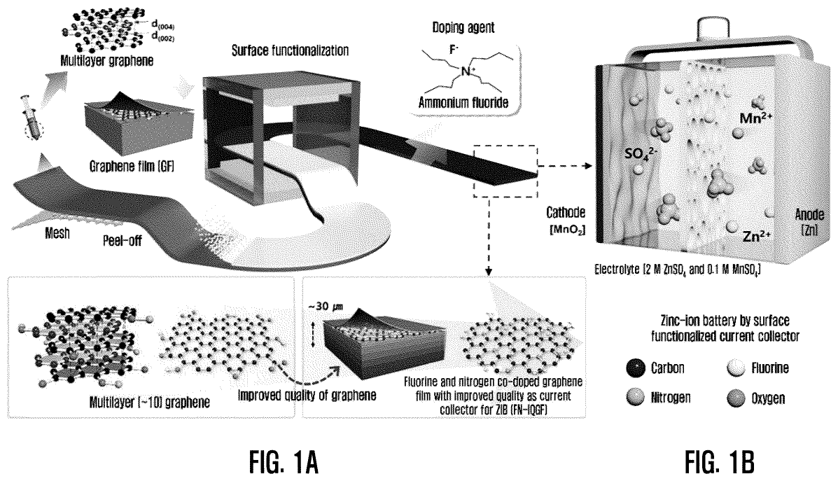

FIG. 1A is a diagram schematically illustrating a process of fabricating a fluorine and nitrogen co-doped improved-quality graphene film (FN-IQGF) using surface functionalization according to an embodiment of the present disclosure, and FIG. 1B is a diagram schematically illustrating a zinc-ion battery (ZIB) including an FN-IQGF as a multifunctional current collector.

Referring to FIG. 1A, a step of preparing a graphene film, a step of coating the graphene film with a compound including a heteroatom, and a step of performing a heat treatment are illustrated.

In an embodiment, the step of preparing the graphene film includes a step of preparing a mixed solution by mixing multilayer graphene and a polymer in a solvent; a step of casting the mixed solution on a mesh and drying the graphene film; and a step of separating the dried graphene film from the mesh.

In an embodiment, the step of preparing the mixed solution is a step of mixing multilayer graphene and a polymer.

In an embodiment, the solvent may include water, an organic solvent, or both.

In an embodiment, the organic solvent may include at least one selected from a group consisting of N-methyl-2-pyrrolidone (NMP), N,N-dimethylacetamide (DMAc), dimethylformamide (DMF), dimethyl sulfoxide (DMSO), tetrahydrofuran (THF), pyridine, propanol, acetone, methanol, and ethanol.

Desirably, the organic solvent may be N-methyl-2-pyrrolidone (NMP).

In an embodiment, the polymer may include at least one selected from a group consisting of polyvinylidene fluoride (PVDF), polyvinylpyrrolidone (PVP), polyvinyl alcohol (PVA), polyvinyl acetate (PVAc), polystyrene (PS), polymethyl methacrylate (PMMA), poly(n-butyl acrylate) (PBA), polyacrylonitrile (PAN), polyaniline (PANi), polyacrylic acid (PAA), polyester-amides (PEA), polyethylene (PE), polyvinyl chloride (PVC), polyvinylidene chloride (PVDC), polyurethane (PU), polychloroprene, polyisoprene, and polybutadiene.

Desirably, the polymer may be polyvinylidene fluoride (PVDF).

In an embodiment, the multilayer graphene may be obtained by stacking 2 to 10 graphene layers; 2 to 8 graphene layers; 2 to 6 graphene layers; 2 to 4 graphene layers; 4 to 10 graphene layers; 4 to 8 graphene layers; 4 to 6 graphene layers; 6 to 10 graphene layers; 6 to 8 graphene layers; or 8 to 10 graphene layers.

Desirably, the multilayer graphene may be obtained by stacking 10 graphene layers.

In an embodiment, the step of casting the mixed solution on the mesh and drying the graphene film may be casting the mixed solution on a metal mesh, and drying the graphene film at a temperature of 30° C. to 80° C.; 30° C. to 60° C.; 30° C. to 40° C. to 80° C.; 40° C. to 60° C.; 50° C. to 80° C.; 50° C. to 60° C.; or 60° C. to 80° C. and in a vacuum or an atmosphere including at least one of air, oxygen, and an inert gas.

In an embodiment, the step of separating the dried graphene film from the mesh may be peeling off the graphene film from the mesh.

In an embodiment, the compound including the heteroatom may include at least one selected from a group consisting of ammonium fluoride (NH₄F), ammonium bifluoride (NH₄HF₂), sodium borohydride (NaBH₄), lithium borohydride (LiBH₄), potassium borohydride (KBH₄), magnesium borohydride (Mg(BH₄)₂), calcium borohydride (Ca(BH₄)₂), strontium borohydride (Sr(BH₄)₂), tris(trimethylsilyl)phosphine, tris(dimethylamino)phosphine, trioctylphosphine (TOP), tri-butylphosphine, tri-phenylphosphine, tri(o-toyl) phosphine, trioctylphosphine oxide (TOPO), triphenyl phosphine oxide, tributyl phosphine oxide, sodium sulfide nonahydrate, thiourea, and ammonium persulfate.

Desirably, the compound including the heteroatom may be ammonium fluoride (NH₄F).

In an embodiment, the heat-treating of the graphene film coated with the heteroatom may be performing a thermal reduction process at a temperature of 300° C. to 600° C.; 300° C. to 500° C.; 300° C. to 400° C.; 400° C. to 600° C.; 400° C. to 500° C.; or 500° C. to 600° C. and in a vacuum or an atmosphere including at least one of air, oxygen, and an inert gas.

In an embodiment, the graphene film may be heat-treated under a process condition in which a portion or all of ammonium ions physisorbed to the graphene film may be converted into nitrogen (pyrrolic-N) of a pyrrole bond, nitrogen (pyridinic-N) of a pyridine bond, or nitrogen (graphitic-N) of a graphite bond.

In an embodiment, an oxygen-containing group of the graphene film may be removed by the heat-treating. By the above reduction process, the total amount of oxygen-containing groups in the graphene film may be reduced and the electrical conductivity may be enhanced.

A zinc-ion battery according to still another embodiment of the present disclosure includes the current collector for the zinc-ion battery described above, or a current collector for a zinc-ion battery manufactured by the method described above; a cathode; a zinc anode; and a gel electrolyte.

In an embodiment, the cathode may be manganese dioxide (MnO₂).

In an embodiment, the gel electrolyte may include at least one selected from a group consisting of polyvinyl alcohol (PVA), zinc sulfate (ZnSO₄), manganese sulfate (MnSO₄), vanadium sulfate (VOSO₄), phosphoric acid (H₃PO₄), sulfuric acid (H₂SO₄), sodium hydroxide (NaOH), potassium hydroxide (KOH), calcium hydroxide (Ca(OH)₂), and magnesium hydroxide (Mg(OH)₂).

Desirably, the gel electrolyte may include polyvinyl alcohol (PVA) and zinc sulfate (ZnSO₄).

In an embodiment, the zin-ion battery may have a maximum energy density of 200 W h kg⁻¹ to 400 W h kg⁻¹ at a power density of 270 W kg⁻¹, and have a maximum energy density of 100 W h kg⁻¹ to 200 W h kg⁻¹ at a power density of 1,800 W kg⁻¹.

In an embodiment, the zin-ion battery may have specific capacities of 150 mAh g⁻¹ to 400 mA hg⁻¹ at a current density of 0.3 A g⁻¹ to 2.0 A g⁻¹, and have a capacitance retention rate of 80% or greater after “120” cycles at a current density of 0.5 A g⁻¹.

The zinc-ion battery according to an embodiment of the present disclosure may have a high specific capacity of 380 mAh g⁻¹ at a current density of 0.3 A g⁻¹ and a capacitance retention rate of 82.4% for up to “120” cycles at a current density of 0.5 A g⁻¹, and may exhibit an excellent cycling stability, a high energy density of 135 W h kg⁻¹ and a power density of 270 W kg⁻¹, and an all-solid-state ZIB may exhibit an excellent mechanical flexibility and stability.

The zinc-ion battery according to an embodiment of the present disclosure is excellent in energy storage performance due to excellent electrical conductivity, charge transfer, ion diffusion ability, and specific capacity. The energy storage performance is enhanced due to the following significant factors. First, an oxygen functional group included in the graphene film may be removed by a thermal reduction process, to enhance the electrical conductivity. In addition, due to the nitrogen-doping effect, the electrical conductivity may be enhanced. Lastly, due to the fluorine-doping effect, the wettability may be enhanced. Due to the above effects, a capacity and cycling performance of a battery may be enhanced.

Hereinafter, the present disclosure is described in more detail based on examples and comparative examples.

However, the following examples are only for illustrating the present disclosure, and the description of the present disclosure is not limited to the following examples.

In the present disclosure, a new strategy for a fabrication of fluorine and nitrogen co-doped improved-quality graphene film (FN-IQGF) as a multifunctional current collector for ZIBs was proposed, and a reduction of oxygen-containing groups and a heteroatom-doped structure were examined. The results revealed that surface functionalization enhanced the electrical conductivity and wettability of the multifunctional current collector, thus enhancing the energy storage performance of the ZIBs. In addition, a mechanical stability and electrochemical kinetics after a cycling test were investigated to verify applying of an optimized current collector for high-performance ZIBs in an aqueous electrolyte. The results revealed that an outstanding mechanical flexibility of a device enables a delivery of an excellent voltage retention under extreme states including bending tests, as well as cut states and even under water. The purpose of the present disclosure was to determine factors that influence electrochemical performance of different types of aqueous rechargeable batteries. Therefore, a relationship between a current collector/electrode material and a mechanical deterioration and capacitive characteristics of the ZIBs were established and demonstrated.

Due to satisfactory safety levels, low cost, and easy assembly of zinc-ion batteries (ZIBs), ZIBs have attracted attention as promising energy storage devices. However, intrinsic deficiency of a carbon-based current collector used to enhance energy storage performance of ZIBs has limited further application of ZIBs. To address the above issues, technical streaming of current collectors via functionalization of their surfaces to enhance their chemical activity has emerged as a promising method for future-oriented ZIBs. In embodiments of the present disclosure, a fluorine and nitrogen co-doped improved-quality graphene film was fabricated as a multifunctional current collector for ZIBs, and the synergistic effect of the increased electrical conductivity and improved wettability of the current collector on the electrochemical performance of ZIBs was demonstrated. The results revealed that the fabricated ZIB exhibited a high specific capacity of 380 mAh g⁻¹ at a current density of 0.3 A g⁻¹, a remarkable cycling stability with a capacity retention rate of 82.4% for up to “120” cycles at a current density of 0.5 A g⁻¹, and a high energy density of 135 W h kg⁻¹ and a power density from 270 W kg⁻¹. In addition, the all-solid-state ZIB exhibited an outstanding mechanical flexibility and safety.

### Experiment

To fabricate a graphene film (GF), a homogeneously mixed solution of multilayer graphene and polyvinylidene difluoride (PVDF) in N-methyl-2-pyrrolidone (NMP) was poured onto a stainless-steel (SUS) mesh and dried at 80° C. Subsequently, the GF was separated from the SUS mesh to obtain a GF. To synthesize the FN-IQGF, which was used as a surface functionalized current collector for ZIBs, ammonium fluoride (NH₄F) was coated on the obtained GF, after which the film was thermally reduced using heat treatment at 400° C. under vacuum. Subsequently, the prepared film was sequentially washed using hydrochloric acid and distilled water. To verify the heteroatom doping effect of the surface functionalized current collector for ZIBs, an undoped IQGF was prepared using the same reduction process without NH₄F.

Morphologies of the GF, the IQGF, and the FN-IQGF were examined using field emission scanning electron microscopy (FESEM, the Core-Facility Center of Gyeongsang National University) and high-resolution transmission electron microscopy (HR-TEM, KBSI Gwangju center). A distribution of all elements in the FN-IQGF was investigated using energy-dispersive spectrometry (EDS)-mapping. Chemical bonding states, crystal nature, and chemical compositions of the GF, the IQGF, and the FN-IQGF were investigated using X-ray photoelectron spectroscopy (XPS), X-ray diffraction (XRD), and thermogravimetric analysis (TGA) under ambient atmosphere in a temperature range from 150 to 1,000° C. A differential scanning calorimetry (DSC) analysis was performed in a temperature range from 100 to 300° C. Lattice defects of the GF, the IQGF, and the FN-IQGF were examined using Raman spectroscopy at a laser-excitation wavelength of 532.1 nm. A wettability of the GF, the IQGF, and the FN-IQGF at an interface of samples was measured using measurements of contact angles. An electrical conductivity of the GF, the IQGF, and the FN-IQGF was evaluated using a Hall effect measurement system.

An electrochemical behavior and energy storage performance were evaluated using as-prepared GF, IQGF, and FN-IQGF as the current collector, using manganese dioxide (MnO₂) as a cathode material, using a Zn foil as an anode, and using a mixed solution of 2 M zinc sulfate (ZnSO₄) and 0.1 M manganese sulfate (MnSO₄) as an electrolyte. Cathodes were fabricated by coating a slurry mixed with MnO₂ as an active material, PVDF as a binder, and Ketien Black as a conductive material (mass ratio of 7:2:1) in NMP on the GF, the IQGF, and the FN-IQGF, after which the electrode was dried at 100° C. Subsequently, electrochemical impedance spectroscopy (EIS) was performed by applying a frequency range of 10⁵ to 10⁻² Hz. The rate performance of ZIBs was measured at current densities of 0.3 to 2.0 A g⁻¹, and the cycling stability was evaluated at a current density of 1.5 A g⁻¹ for “120” cycles. After cycling tests, an electrode stability of the samples was investigated using three-dimensional (3D) surface confocal laser scanning microscopy (3D surface microscope) and cross-sectional scanning electron microscope equipped with EDS mapping. Furthermore, an all-solid-state ZIB was fabricated using a gel electrolyte including ZnSO₄ and polyvinyl alcohol (PVA, M_{w}: 89,000˜98,000) in distilled water, with the same anode and cathode, and cellulose separator. The energy storage performance was measured by measuring the rate performance at current densities of 0.3 to 1.0 A g⁻¹. A mechanical bending test of the fabricated ZIBs was performed at a current density of 0.5 A g⁻¹.

### Results and Discussion

The diagram schematically illustrating a process of fabricating an FN-IQGF as a surface-functionalized current collector is illustrated in FIG. 1A. First, a GF was prepared by stacking multilayer graphene. To reduce an oxygen phase of the GF, a reduction process was performed using heat treatment. In addition, a surface of the GF was functionalized by a thermal decomposition of NH₄F to dope heteroatoms (i.e., fluorine and nitrogen). Lastly, a high-performance ZIB was manufactured using the obtained FN-IQGF as the surface-functionalized current collector, which provided an electron pathway between an electrode material and an external terminal of a device, as illustrated in FIG. 1B.

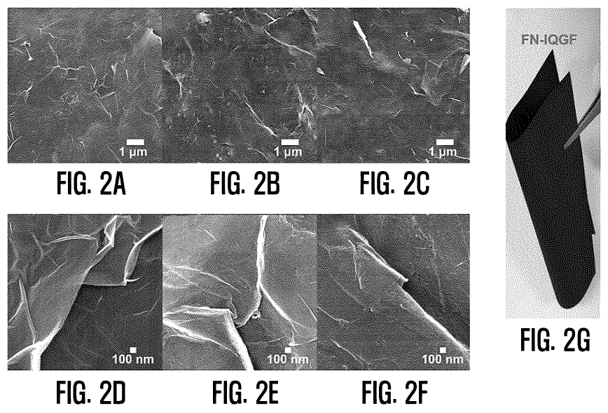

FIGS. 2A and 2B illustrate a scanning electron microscopy (SEM) image and an enlarged SEM image of a GF, FIGS. 2B and 2E illustrate an SEM image and an enlarged SEM image of an IQGF, FIGS. 2C and 2F illustrate an SEM image and an enlarged SEM image of an FN-IQGF, and FIG. 2G illustrates a photograph of the FN-IQGF in a rolled state.

To investigate an effect of surface functionalization on morphologies of prepared films, low-and high-magnification SEM images of the GF (FIGS. 2A and 2D), the IQGF (FIGS. 2B and 2E), and the FN-IQGF (FIGS. 2C and 2F) were obtained. The SEM images revealed that all the above films exhibited flake-like morphology of stacked graphene without any impurities, which indicates that a surface functionalization process did not have an influence on the morphologies of the films. In addition, a flexibility of an FN-IQGF current collector was verified by rolling a material (FIG. 2G).

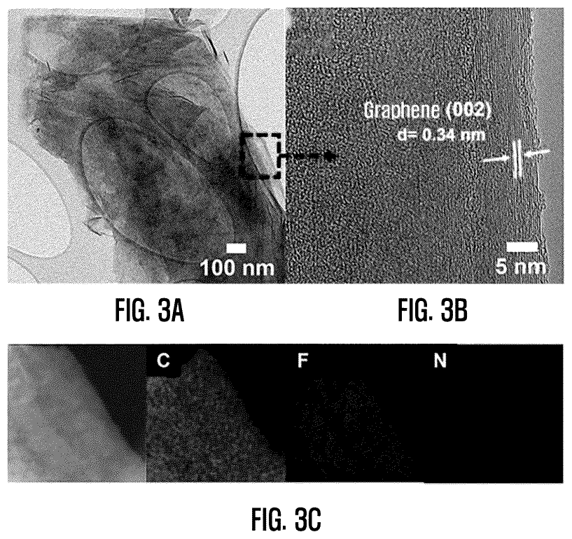

FIGS. 3A and 3B illustrate low-and high-magnification transmission electron microscopy (TEM) images of an FN-IQGF film according to an embodiment of the present disclosure, and FIG. 3C illustrates energy-dispersive spectrometry (EDS) images with elemental distribution.

FIGS. 3A and 3B illustrate the low and high-resolution TEM images of the FN-IQGF. Graphene layers of a film exhibited a distinct two-dimensional structure with a d-spacing of 0.34 nm, which corresponded to a (002) plane of carbon. To further examine distributions of C, F, and N atoms in a graphene matrix of the FN-IQGF, EDS mapping was performed, and the results are illustrated in FIG. 3C. The images revealed that atoms were uniformly dispersed along the graphene matrix. The above results distinctly verified a heteroatom-doped structure of the FN-IQGF fabricated using surface functionalization.

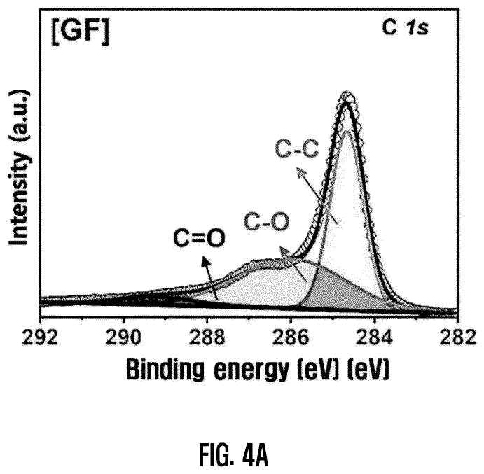

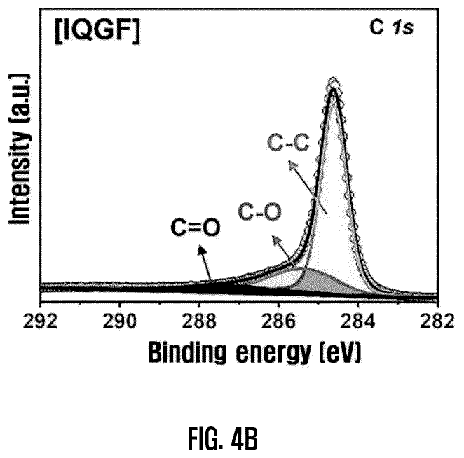

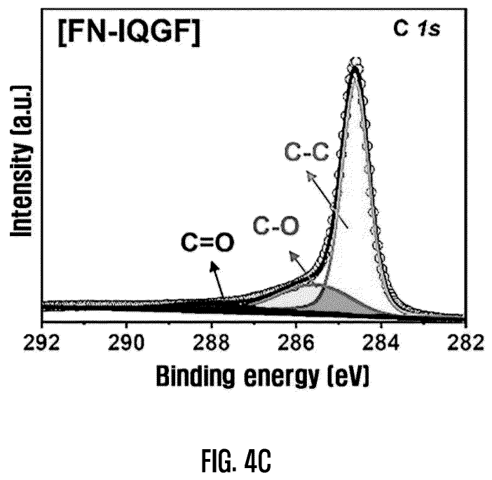

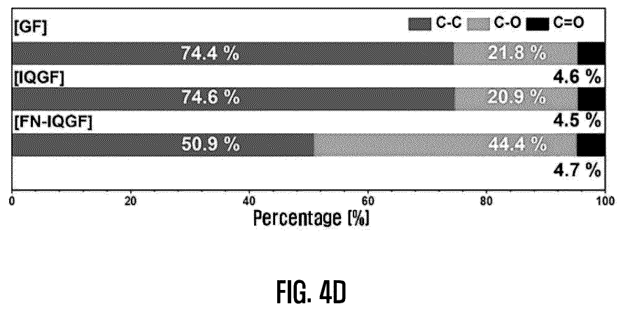

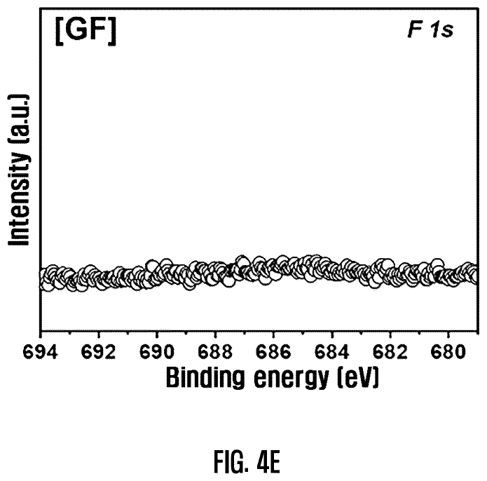

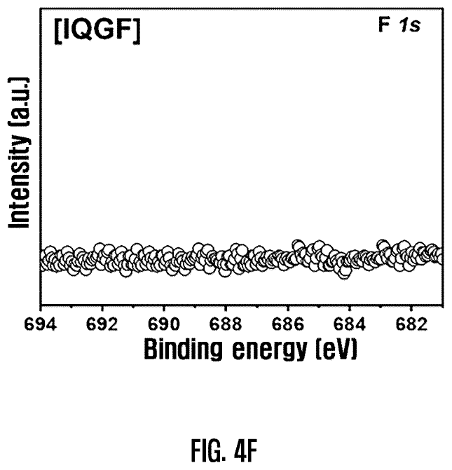

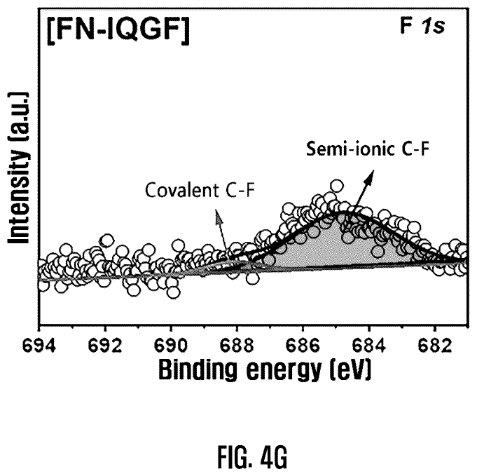

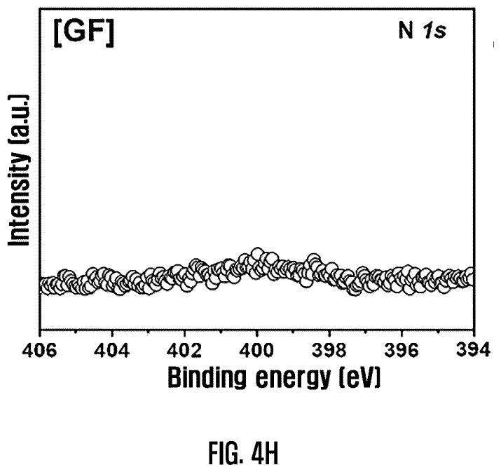

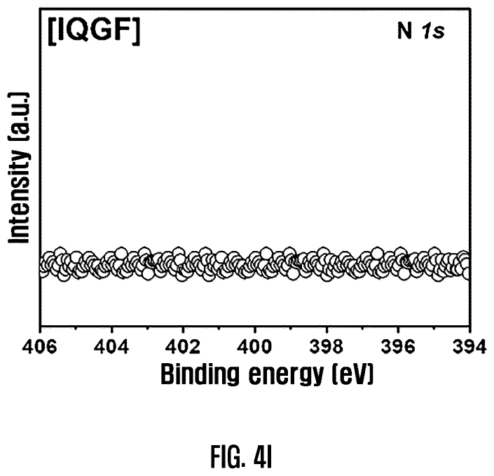

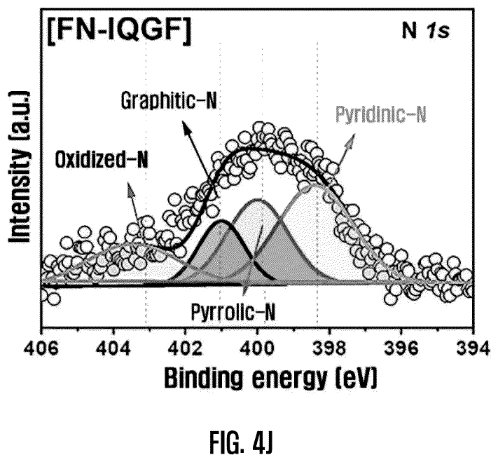

FIGS. 4A to 4C illustrate C 1s X-ray photoelectron spectroscopy (XPS) spectra of a GF, an IQGF, and an FN-IQGF according to an embodiment of the present disclosure, FIG. 4D illustrates percentages of oxygen-containing groups of the GF, the IQGF, and the FN-IQGF according to an embodiment of the present disclosure, FIG. 4E illustrates F 1s XPS spectra of the GF, the IQGF, and the FN-IQGF according to an embodiment of the present disclosure, and FIGS. 4H to 4J illustrate N 1s XPS spectra of the GF, the IQGF, and the FN-IQGF according to an embodiment of the present disclosure.

The C 1s spectra of the GF, the IQGF, and the FN-IQGF are illustrated in FIGS. 4A to 4C, respectively. Peaks were observed in the spectra of the samples at ˜284.5, 286.5, and 288.3 eV (C—C, C—O, and C═O bonds, respectively). In addition, a ratio of oxygen-containing groups in various samples was verified and illustrated in FIG. 4D. In comparison to those of the GF, C 1s spectral peaks of the IQGF and the FN-IQGF may be deconvoluted into oxygen-containing groups on surfaces thereof, indicating that a reduction process improved the quality of the GF, which is expected to enhance electrical properties. Thus, enhanced rate performance in ZIBs is provided. The F 1s spectra and the N 1s spectra of the GF, the IQGF, and the FN-IQGF are illustrated in FIGS. 4E to 4J. Since F and N sources are absent, a peak was not observed in the spectra of the GF (FIGS. 4E and 4H) and the IQGF (FIGS. 4F and 4I).

In contrast, peaks corresponding to semi-ionic C—F (˜684.6 eV) and covalent C—F (˜687.9 eV; FIG. 4g), and pyridinic N (˜398.4 eV), pyrrolic N (˜400.0 eV), graphitic N (˜401.0 eV), and oxidized N (˜403.0 eV) were observed in the spectra of the FN-IQGF, which may be attributed to a successful co-doping of F and N (FIG. 4J). In addition, a fluorine and nitrogen co-doping structure of the FN-IQGF may enhance the energy storage performance of ZIBs owing to electronegativities of nitrogen (3.04) and fluorine (3.98) atoms compared to that of C atom (2.55). Furthermore, C—F bonding may enhance the overall capacity and cycling stability via efficient use of an interface between a current collector and an electrode material due to easy access to ions during cycling. In addition, C—N bonding may enhance the electrical conductivity by altering an electronic structure that induces an electron density state of C, to increase the rate performance of the ZIBs.

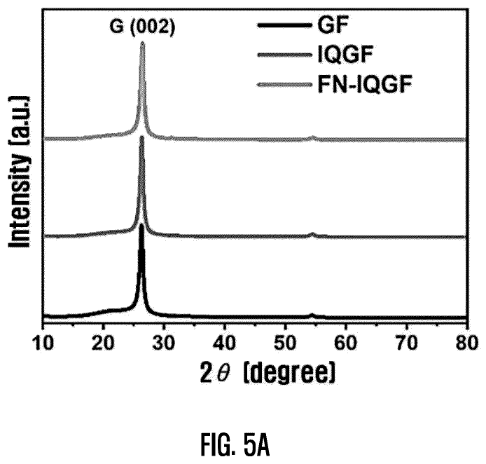

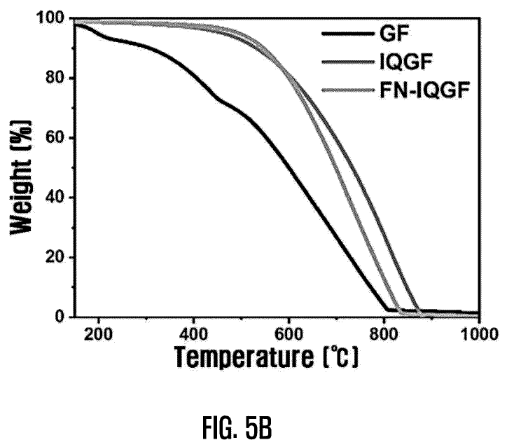

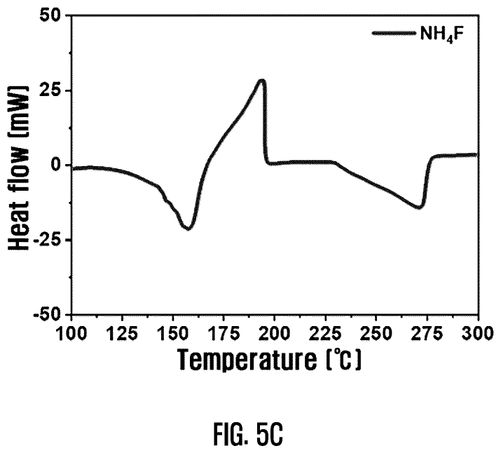

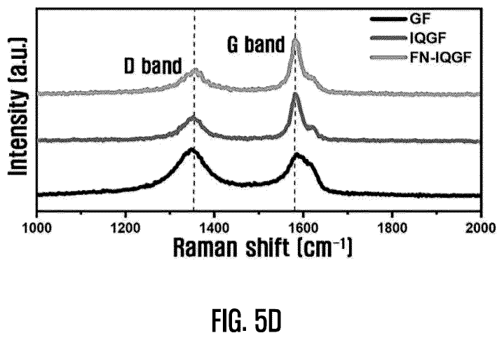

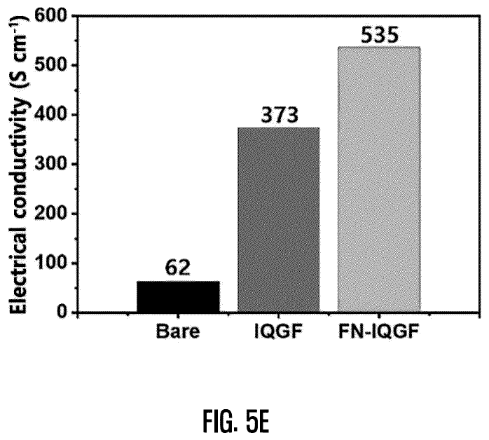

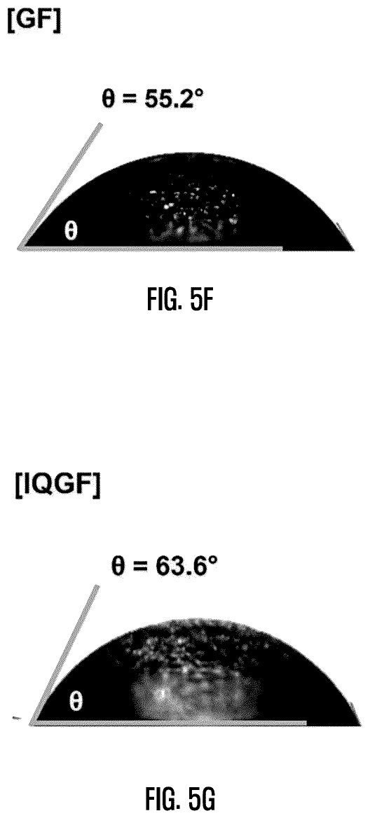

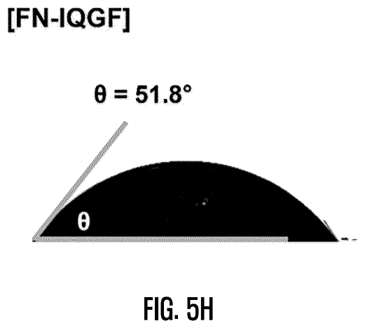

FIG. 5A illustrates X-ray diffraction (XRD) patterns of a GF, an IQGF, and an FN-IQGF according to an embodiment of the present disclosure, FIG. 5B illustrates thermogravimetric analysis (TGA) curves of the GF, the IQGF, and the FN-IQGF according to an embodiment of the present disclosure, FIG. 5C illustrates a differential scanning calorimetry (DSC) curve of the GF, the IQGF, and the FN-IQGF according to an embodiment of the present disclosure, FIG. 5D illustrates Raman spectra of the GF, the IQGF, and the FN-IQGF according to an embodiment of the present disclosure, FIG. 5E illustrates electrical conductivities of the GF, the IQGF, and the FN-IQGF according to an embodiment of the present disclosure, and FIGS. 5F to 5H illustrate results obtained by measuring contact angles of the GF, the IQGF, and the FN-IQGF according to an embodiment of the present disclosure.

XRD results revealing crystal structures of the GF, the IQGF, and the FN-IQGF are illustrated in FIG. 5A. All the films exhibited a diffraction peak at 26.5°, which corresponded to a (002) layer of graphite. Furthermore, the TGA curves revealed that a pure sample exhibited a 100% weight loss owing to a lack of impurities in pure carbon. In addition, a weight loss curve of the IQGF and FN-IQGF right shifted as the temperature increased, which indicates that the samples exhibited improved thermal stability due to a reduction of oxygen-containing groups (FIG. 5B). Moreover, an effect of NH₄F as a fluorine or nitrogen-doping source on a thermal decomposition of a carbon structure was demonstrated using the DSC curve (FIG. 5C). Endothermic peaks were observed in the DSC curve at ˜157 and 270° C. To investigate lattice defects and graphitic carbon of all the samples, their Raman spectra were obtained. Peaks were observed at ˜1350 (D-band) and 1596 cm⁻¹ (G-band), as illustrated in FIG. 5D.

In addition, intensity ratios (I_{G}/I_{D}) of the G-band and the D-band of the GF, the IQGF, and the FN-IQGF were 0.90, 1.25, and 1.24, respectively, which indicates a successful removal of oxygen-containing groups in the GF by the reduction process. Furthermore, a bar chart in FIG. 5E clearly reveals a gradual increase in the electrical conductivity after the surface functionalization, which may be attributed to the reduction of oxygen-containing groups. In particular, the FN-IQGF exhibited enhanced electrical conductivity compared to the IQGF, which indicates that the N-doping effect may enhance the electrical conductivity by altering an electronic structure. Accordingly, the FN-IQGF was expected to exhibit improved rate performance due to the enhanced electrical conductivity thereof. An interface operation between an electrode material and a current collector is a significant factor for improving energy storage performance of ZIBs.

Thus, contact angles of the samples were measured. The GF exhibited a low contact angle of 55.2° (FIG. 5F), which may be attributed to a large quantity of oxygen-containing groups on a surface. In addition, the contact angle of the IQGF (FIG. 5G) increased to 63.6° due to the reduction of oxygen-containing groups. In contrast, the FN-IQGF exhibited a reduced contact angle of 51.8° (FIG. 5H), which could be attributed to the presence of fluorine-doping sites in the graphene structure, which enhanced the wettability on the surface. The above results indicate that the FN-IQGF exhibited the enhanced wettability due to the presence of fluorine-doping sites on the surface, which is expected to increase a cycling stability via an efficient interface operation between the electrode material and the current collector.

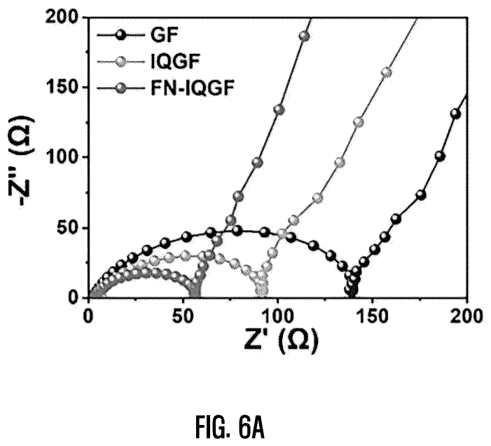

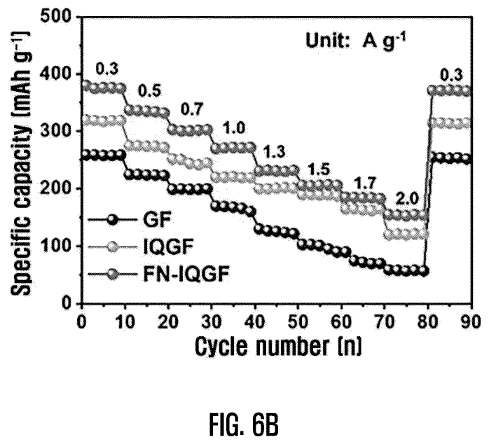

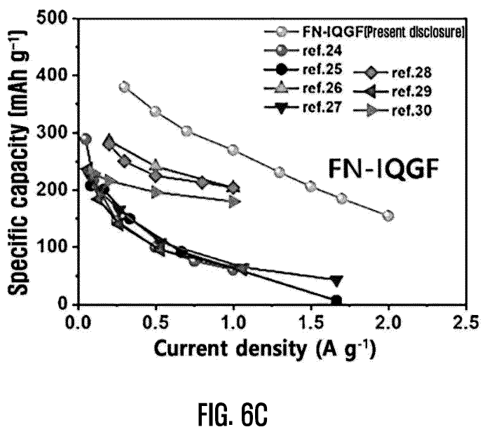

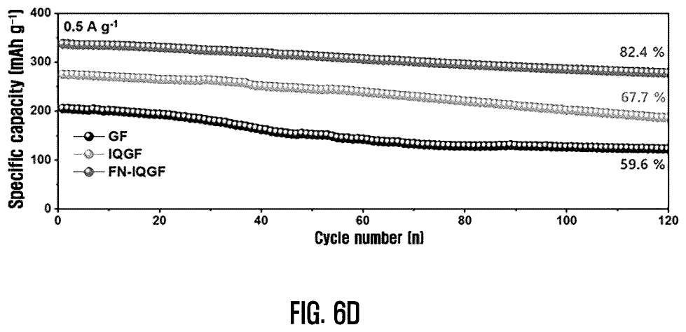

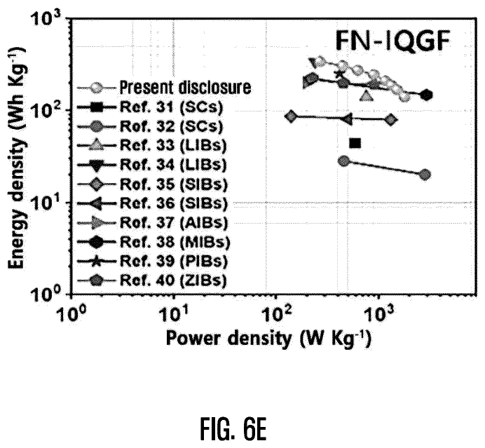

FIG. 6A illustrates Nyquist plots of a GF, an IQGF, and an FN-IQGF according to an embodiment of the present disclosure, FIG. 6B illustrates rate performance of the GF, the IQGF, and the FN-IQGF according to an embodiment of the present disclosure, FIG. 6C illustrates a result of a comparison between rate performance of the FN-IQGF according to an embodiment of the present disclosure and those of previously reported ZIBs, FIG. 6D illustrates cyclic stabilities of the GF, the IQGF, and the FN-IQGF according to an embodiment of the present disclosure, and FIG. 6E illustrates a Ragone plot for comparing power densities and energy densities of the GF, the IQGF, and the FN-IQGF according to an embodiment of the present disclosure to power densities and energy densities of previously reported energy storage devices.

EIS Nyquist plots (FIG. 6A) of the GF, the IQGF, and the FN-IQGF exhibited a semi-circle slope in a high-frequency region and a linear slope in a low-frequency region, which corresponded to a charge-transfer resistance (R_{ct}) and Warburg impedance, respectively. In addition, a charge-transfer resistance of the FN-IQGF was lower than those of the GF and the IQGF, which indicates an outstanding charge-transfer process of the FN-IQGF, which may be ascribed to an increase in an electrical conductivity of the FN-IQGF due to a reduction of oxygen-containing groups and a nitrogen-doping effect. Rate performance of various ZIBs including a GF, an IQGF, and an FN-IQGF as surface-functionalized current collectors is illustrated in FIG. 6B. A ZIB fabricated using the FN-IQGF exhibited specific capacities of 380, 337, 303, 270, 231, 206, 185, and 155 mAh g⁻¹ at current densities of 0.3, 0.5, 0.17, 1.0, 1.3, and 2.0 A g⁻¹, respectively, with an outstanding capacity retention rate of 97%.

In addition, the rate performance of the FN-IQGF exhibited higher specific capacities compared to those of previously reported ZIBs fabricated using MnO₂ cathodes (FIG. 6C). The above results may be attributed to an improved charge transfer process due to the enhanced electrical conductivity of the current collector via the reduction of oxygen-containing groups and the nitrogen-doping effect. The long-term stability of the GF, the IQGF, and the FN-IQGF for up to “120” cycles at a current density of 0.5 A g⁻¹ is illustrated in FIG. 6D. The FN-IQGF demonstrated an excellent capacity retention rate of 82.4% compared to those of the GF (59.6%) and the IQGF (67.7%), and thus, it can be found that an improved wettability of the current collector effectively managed an interface between the current collector and the cathode material. Furthermore, the FN-IQGF exhibited a maximum energy density of 270 W h kg⁻¹ at a power density of 270 W kg⁻¹, and an energy density of 139 W h kg⁻¹ at a power density of 1,800 W kg⁻¹. The above energy densities were significantly higher than those of previously reported LIBs, potassium-ion, magnesium-ion, aluminum-ion, and sodium-ion batteries, as illustrated in the Ragone plots in FIG. 6E.

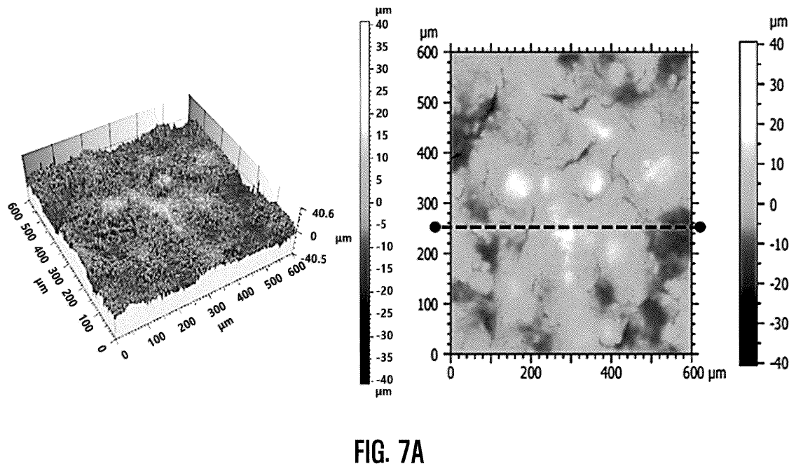

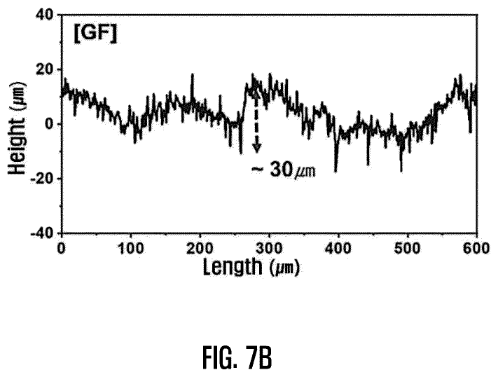

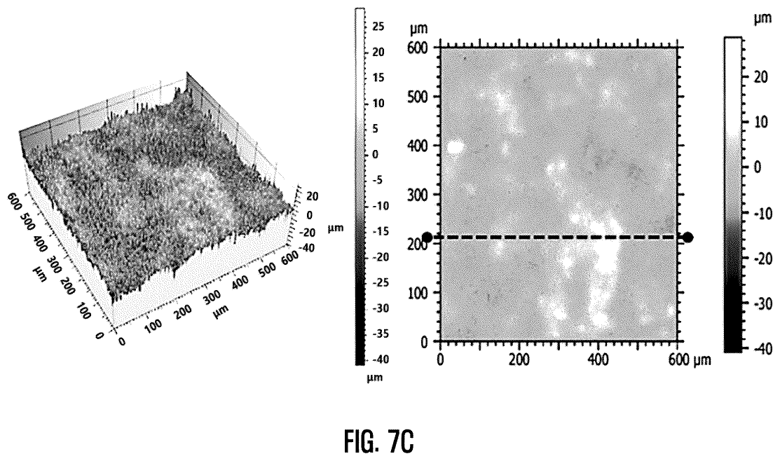

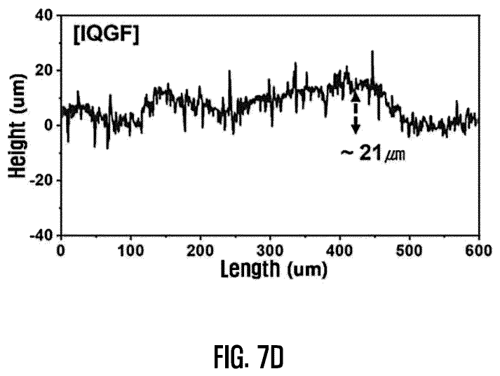

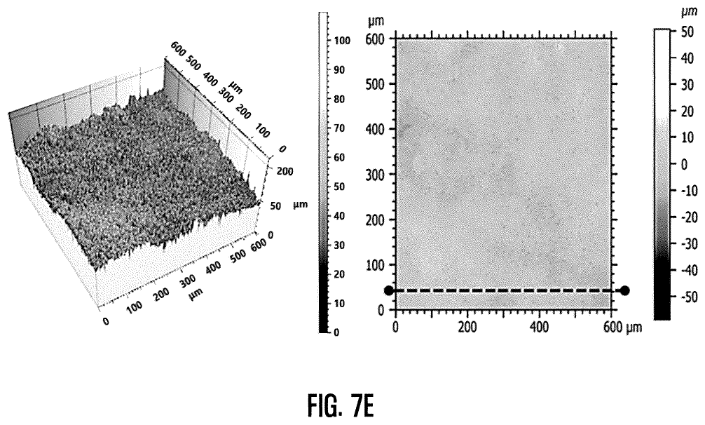

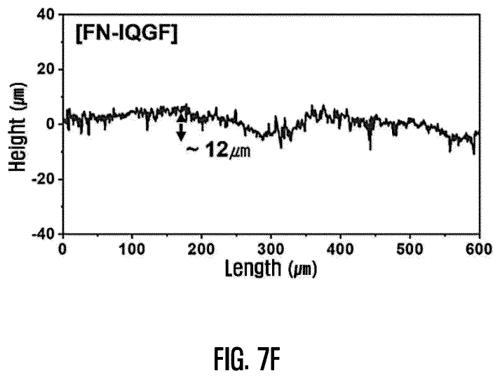

FIGS. 7A and 7B illustrate a 3D surface image and a resultant height plot of a GF electrode according to an embodiment of the present disclosure, FIGS. 7C and 7D illustrate a 3D surface image and a resultant height plot of an IQGF electrode according to an embodiment of the present disclosure, and FIGS. 7E and 7F illustrate a 3D surface image and a resultant height plot of an FN-IQGF electrode according to an embodiment of the present disclosure.

To examine a structural stability of the prepared cathodes for ZIBs after a cycling test, surfaces of the GF electrode, the IQGF electrode, and the FN-IQGF electrode were characterized using a 3D surface microscope, and the images are illustrated in FIGS. 7A to 7F. The GF electrode exhibited an irregular surface with a large stepped cone of ˜30 μm (FIGS. 7A and 7B), which indicates a poor stability of an interface between a current collector and an electrode material. In contrast, the IQGF electrode (FIGS. 7C and 7D) exhibited a slightly improved structural stability, which may be attributed to an enhanced charge transfer process due to an increased electrical conductivity. In addition, the FN-IQGF electrode (FIGS. 7E and 7F) exhibited a smooth surface with a small stepped cone of ˜12 μm. The above results indicate that an improved charge transfer process and enhanced wettability of the FN-IQGF current collector effectively provided a stable interface for insertion/extraction of Zn ions, thereby enhancing a long-term stability of ZIBs.

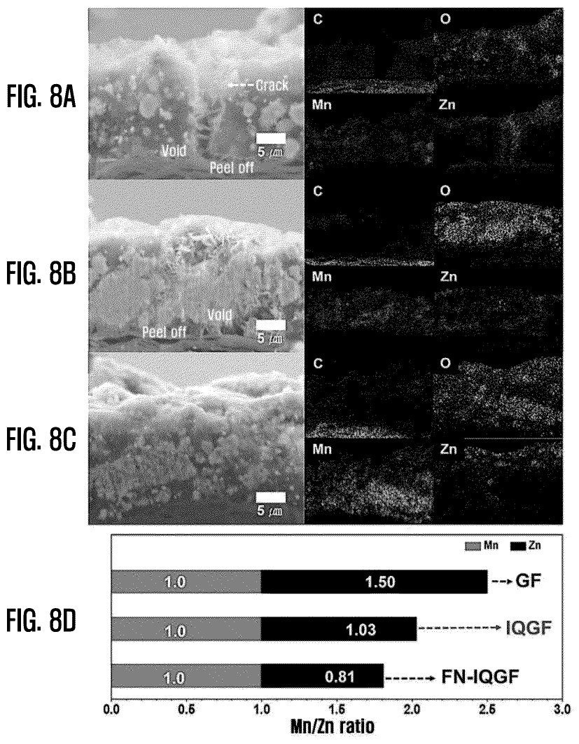

FIGS. 8A to 8C illustrate cross-sectional SEM images and EDS mappings of a GF electrode, an IQGF electrode, and an FN-IQGF electrode after a cycling test according to embodiments of the present disclosure; and FIG. 8D illustrates a ratio of Mn to Zn obtained from the EDS mappings.

To further examine an electrode structure after the cycling test, a cross-sectional SEM and EDS analysis was performed, and the results are illustrated in FIG. 8. MnO₂ with an average diameter of ˜20 μm was deposited as an electrode material on a current collector. Notable cracks and voids were observed in the GF electrode (FIG. 8A), as well as a peel-off of MnO₂ from the current collector. This indicates an unstable interface between the electrode material and the current collector due to a low electrical conductivity of the current collector. In addition, voids were observed at an interface between MnO₂ and the IQGF electrode (FIG. 8B), which may be attributed to a weak interfacial adhesion due to a low wettability of the current collector.

In contrast, the FN-IQGF electrode (FIG. 8C) exhibited a stable electrode structure without cracks or voids. Therefore, an outstanding cycling stability of the electrode was verified. A reversibility of prepared cathodes after the cycling test was further investigated based on Zn to Mn ratios using EDS mapping data (FIG. 8D). After the cycling test, the FN-IQGF electrode exhibited a superb reversibility with a Mn:Zn ratio of 0.81, compared to those of the GF electrode (1.50) and the IQGF electrode (1.03). The above results may be ascribed to an excellent stability of the FN-IQGF electrode for ZIBs. In particular, the improved wettability of the FN-IQGF facilitated an efficient electron transfer between the electrode material and the current collector. The above results indicate that the highly-reversible FN-IQGF electrode may be an effective electrode for all-solid-state ZIBs.

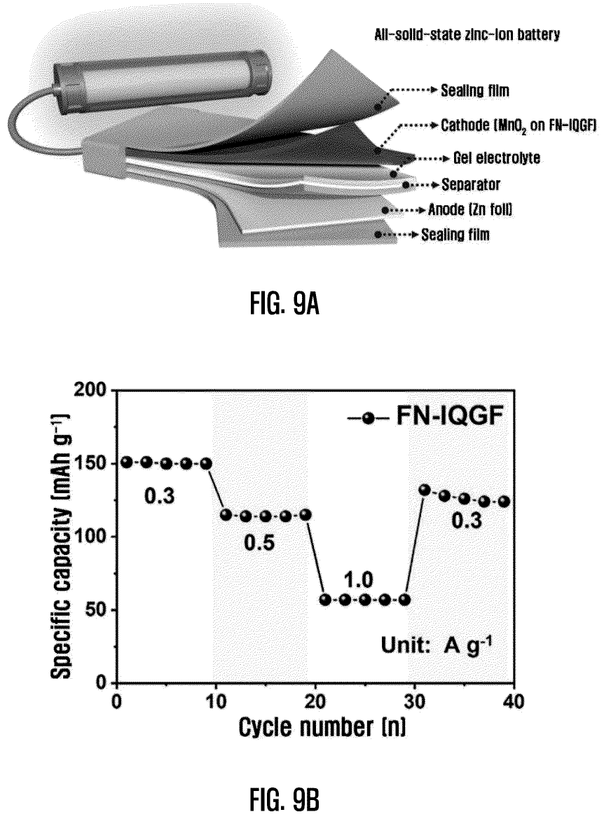

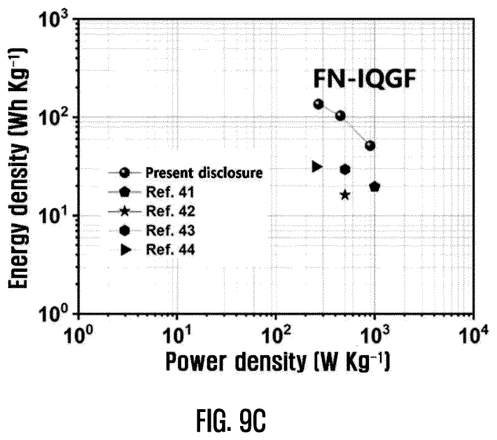

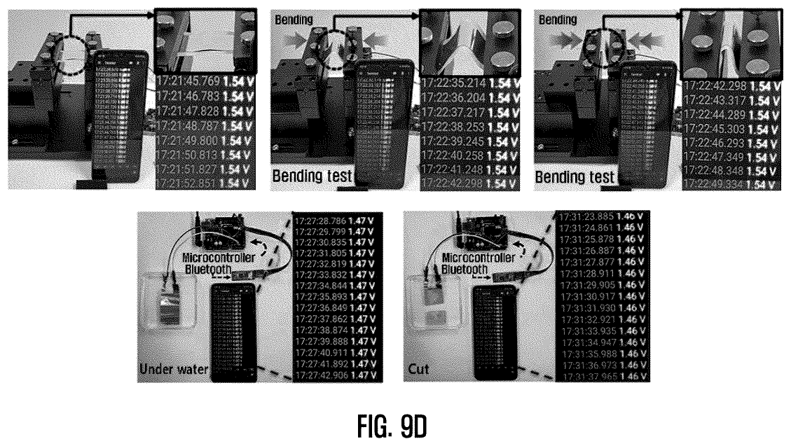

FIG. 9A is a diagram schematically illustrating a structure of an all-solid-state ZIB including an FN-IQGF electrode and a gel electrolyte according to an embodiment of the present disclosure, FIG. 9B illustrates rate performance of the all-solid-state ZIB according to an embodiment of the present disclosure, FIG. 9C illustrates Ragone plots for comparing a power density and an energy density of the all-solid-state ZIB according to an embodiment of the present disclosure to those of previously reported all-solid-state energy storage devices, and FIG. 9D illustrates photographs showing voltage conditions of a smartphone, a microcontroller, and a Bluetooth device connected to the all-solid-state ZIB according to an embodiment of the present disclosure in a straight state, a folded state, a cut state, and even under water.

To investigate the practical application of the FN-IQGF, all-solid-state ZIBs (FIG. 9A) were fabricated using the FN-IQGF as a current collector, a gel-electrolyte including ZnSO₄ and PVA, and a sealing film was introduced. In particular, an introduction of the gel-electrolyte may provide excellent mechanical properties, as well as offset disadvantages of dendrite growth, corrosion, and hydrogen generation of a Zn anode. The rate performance of the all-solid-state ZIB including an FN-IQGF electrode at a voltage range of 1.0 to 1.9 V and a current density of 0.3 to 1.0 A g⁻¹ is illustrated in FIG. 9B. The FN-IQGF exhibited specific capacities of 151, 114, and 57 mA h g⁻¹ at current densities of 0.3, 0.5, and 1.0 A g⁻¹, respectively, and a recovering capacity of 132 mA h g⁻¹ at 0.3 A g⁻¹ (a retention rate of 86%). Moreover, the Ragone plots revealed that the all-solid-state ZIB fabricated using the FN-IQGF exhibited an outstanding energy density of 135 W kg⁻¹ at a power density of 270 W h kg⁻¹, which was higher than those of previously reported all-solid-state energy storage devices (FIG. 9C). In addition, to further examine the practical application of the all-solid-state ZIB including the FN-IQGF, a smartphone, a microcontroller, and a Bluetooth device were connected to the ZIB, as illustrated in FIG. 9D. The photographs confirmed that the ZIB sustained a stable voltage during bending tests, as well as, in a cut state and even under water.

In summary, in embodiments of the present disclosure, the synergistic effect of increased electrical conductivity and improved wettability of the current collector on the electrochemical performance of ZIBs was demonstrated.

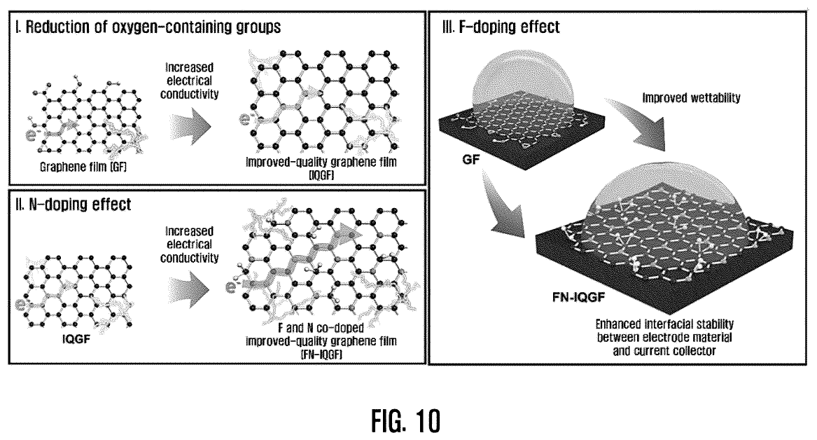

FIG. 10 is a diagram schematically illustrating advantages of an FN-IQGF as a multifunctional current collector according to an embodiment of the present disclosure.

As schematically illustrated in FIG. 10, an electrical conductivity increased due to a reduction in oxygen-containing groups and a nitrogen-doping effect improves a charge-transfer process, thereby increasing the overall specific capacity and rate performance. Meanwhile, a fluorine-doping effect enabled an interface between an electrode and an electrolyte to be efficiently utilized owing to an improved wettability, which enhanced a cycling stability due to a stable electrode structure. In addition, the potential practical application of an all-solid-state ZIB including an FN-IQGF with stable electrochemical performance and excellent mechanical properties in wearable energy storage devices was verified.

### Conclusion

Embodiments of the present disclosure demonstrated a fabrication of an FN-IQGF as a surface-functionalized current collector for ZIBs. In particular, a synergistic effect of the surface functionalized current collector on electrochemical performance of a ZIB was demonstrated. The results revealed that the ZIB including the FN-IQGF provides a remarkable specific capacity of 380 mAh g⁻¹ at a current density of 0.3 A g⁻¹, outstanding rate performance (155 mAh g⁻¹ at a current density of 2.0 A g⁻¹), and a superb cycling stability during “120” cycles at a current density of 0.5 A g⁻¹ with a capacity retention rate of 82.4%.

Superior electrochemical performance was attributed to efficient charge transportation via a reduction of oxygen-containing groups and a nitrogen-doping effect of a current collector, which enhanced the electrical conductivity of the electrode, thereby enhancing the overall specific capacity and rate performance. In addition, the excellent cycling stability was attributed to the stable electrode structure owing to the fluorine-doping effect, which enhanced the wettability of the current collector, thereby enabling the efficient utilization of the interface between the electrode and the electrolyte. Moreover, excellent mechanical properties and feasibility of the FN-IQGF for practical applications were verified using bending tests and operating the all-solid-state ZIB in a cut state and even under water. Embodiments of the present disclosure verified that surface functionalization via a combination of the reduction of oxygen-containing groups and heteroatom-doping of the current collector may provide a new method to fabricate a multifunctional current collector for next-generation ZIBs.

While the embodiments are described with reference to the drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

1. A current collector for a zin-ion battery, the current collector comprising:
a graphene film; and
a heteroatom doped in the graphene film.

2. The current collector for the zin-ion battery of claim 1, wherein the heteroatom comprises at least one selected from a group consisting of fluorine (F), nitrogen (N), sulfur (S), boron (B), and phosphorus (P).

3. The current collector for the zin-ion battery of claim 1, wherein the graphene film is obtained by stacking 2 to 10 multilayer graphene layers.

4. The current collector for the zin-ion battery of claim 1, wherein the graphene film is obtained by removing oxygen-containing groups.

5. The current collector for the zin-ion battery of claim 1, wherein the current collector for the zinc-ion battery is co-doped with fluorine (F) and nitrogen (N).

6. A method of manufacturing a current collector for a zin-ion battery, the method comprising:
preparing a graphene film;
coating the graphene film with a compound comprising a heteroatom; and
heat-treating the graphene film coated with the heteroatom.

7. The method of claim 6, wherein the preparing of the graphene film comprises:
preparing a mixed solution by mixing multilayer graphene and a polymer in a solvent;
casting the mixed solution on a mesh and drying the graphene film; and
separating the dried graphene film from the mesh.

8. The method of claim 7, wherein
the multilayer graphene is obtained by stacking 2 to 10 graphene layers, and
the polymer comprises at least one selected from a group consisting of polyvinylidene fluoride (PVDF), polyvinylpyrrolidone (PVP), polyvinyl alcohol (PVA), polyvinyl acetate (PVAc), polystyrene (PS), polymethyl methacrylate (PMMA), poly(n-butyl acrylate) (PBA), polyacrylonitrile (PAN), polyaniline (PANi), polyacrylic acid (PAA), polyester-amides (PEA), polyethylene (PE), polyvinyl chloride (PVC), polyvinylidene chloride (PVDC), polyurethane (PU), polychloroprene, polyisoprene, and polybutadiene.

9. The method of claim 7, wherein
the solvent comprises water, an organic solvent, or both, and
the organic solvent comprises at least one selected from a group consisting of N-methyl-2-pyrrolidone (NMP), N,N-dimethylacetamide (DMAc), dimethylformamide (DMF), dimethyl sulfoxide (DMSO), tetrahydrofuran (THF), pyridine, propanol, acetone, methanol, and ethanol.

10. The method of claim 7, wherein the casting of the mixed solution on the mesh and drying of the graphene film, comprises casting the mixed solution on a metal mesh, and drying the graphene film at a temperature of 30° C. to 80° C. and in a vacuum or an atmosphere comprising at least one of air, oxygen, and an inert gas.

11. The method of claim 6, wherein the compound comprising the heteroatom comprises at least one selected from a group consisting of ammonium fluoride (NH₄F), ammonium bifluoride (NH₄HF₂), sodium borohydride (NaBH₄), lithium borohydride (LiBH₄), potassium borohydride (KBH₄), magnesium borohydride (Mg(BH₄)₂), calcium borohydride (Ca(BH₄)₂), strontium borohydride (Sr(BH₄)₂), tris(trimethylsilyl)phosphine, tris(dimethylamino)phosphine, trioctylphosphine (TOP), tri-butylphosphine, tri-phenylphosphine, tri(o-toyl) phosphine, trioctylphosphine oxide (TOPO), triphenyl phosphine oxide, tributyl phosphine oxide, sodium sulfide nonahydrate, thiourea, and ammonium persulfate.

12. The method of claim 6, wherein the heat-treating of the graphene film coated with the heteroatom comprises performing a thermal reduction process at a temperature of 300° C. to 600° C. and in a vacuum or an atmosphere comprising at least one of air, oxygen, and an inert gas.

13. The method of claim 6, wherein an oxygen-containing group of the graphene film is removed by the heat-treating.

14. A zin-ion battery comprising:
the current collector for the zin-ion battery of claim 1, or a current collector for a zin-ion battery manufactured by the method of claim 6;
a cathode;
a zinc anode; and
a gel electrolyte.

15. The zin-ion battery of claim 14, wherein the gel electrolyte comprises at least one selected from a group consisting of polyvinyl alcohol (PVA), zinc sulfate (ZnSO₄), manganese sulfate (MnSO₄), vanadium sulfate (VOSO₄), phosphoric acid (H₃PO₄), sulfuric acid (H₂SO₄), sodium hydroxide (NaOH), potassium hydroxide (KOH), calcium hydroxide (Ca(OH)₂), and magnesium hydroxide (Mg(OH)₂).

16. The zin-ion battery of claim 14, wherein the zin-ion battery has a maximum energy density of 200 W h kg⁻¹ to 400 W h kg⁻¹ at a power density of 270 W kg⁻¹, and has a maximum energy density of 100 W h kg⁻¹ to 200 W h kg⁻¹ at a power density of 1,800 W kg⁻¹.

17. The zin-ion battery of claim 14, wherein the zin-ion battery has specific capacities of 150 mAh g⁻¹ to 400 mA hg⁻¹ at a current density of 0.3 A g⁻¹ to 2.0 A g⁻¹, and has a capacitance retention rate of 80% or greater after “120” cycles at a current density of 0.5 A g⁻¹.
